(19) United States
(12) Patent Application Publication
(10) Pub. No.: US 2012/0099818 A1
(43) Pub. Date: Apr. 26, 2012

(54) OPTICAL WAVEGUIDE FOR TOUCH PANEL

(75) Inventors: Naoki Shibata, Osaka (JP); Yusuke Shimizu, Osaka (JP)

(73) Assignee: NITTO DENKO CORPORATION, Osaka (JP)

(21) Appl. No.: 13/267,580

(22) Filed: Oct. 6, 2011

Related U.S. Application Data
(60) Provisional application No. 61/411,095, filed on Nov. 8, 2010.

(30) Foreign Application Priority Data
Oct. 25, 2010 (JP) 2010-238478

(51) Int. Cl. G02B 6/32

(52) U.S. Cl. 385/33

(57) ABSTRACT

The optical waveguide is disposed along the periphery of a display screen of a display of a touch panel. A light-emitting optical waveguide section and a light-receiving optical waveguide section are disposed in an alternating pattern along each edge of the display screen. Both of the light-emitting optical waveguide section and the light-receiving optical waveguide section are coupled together by placing end surfaces of end portions of the light-emitting optical waveguide section and the light-receiving optical waveguide section in abutment with each other. The light-emitting optical waveguide section includes cores each having an end portion provided in the form of a light-emitting lens portion. The light-emitting lens portion has an end surface provided in the form of a light-emitting lens surface. The light-receiving optical waveguide section includes cores each having an end portion provided in the form of a light-receiving lens portion corresponding to the light-emitting lens portion.

### RELATED APPLICATIONS

This application claims the benefit of U.S. Provisional Application No. 61/411,095 filed Nov. 8, 2010, which is hereby incorporated by reference.

### BACKGROUND OF THE INVENTION

1. Field of the Invention

The present invention relates to an optical waveguide for a touch panel which is used as a detection means for detecting a finger touch position and the like in a touch panel.

2. Description of the Related Art

A touch panel is an input device for operating an apparatus by directly touching a display screen of a liquid crystal display and the like with a finger, a purpose-built stylus and the like. The touch panel includes a display that displays operation details and the like, and a detection means that detects the position (coordinates) of a portion of the display screen of the display touched with the finger and the like. Information indicating the touch position detected by the detection means is sent in the form of a signal to the apparatus, which in turn performs an operation and the like displayed on the touch position. Examples of the apparatus employing such a touch panel include ATMs in banking facilities, ticket vending machines in stations, and portable game machines.

A detection means employing an optical waveguide has been proposed as the detection means that detects the finger touch position and the like in the aforementioned touch panel (see for example, Japanese Translation of PCT International Application Publication No. 2006-522987). Specifically, as shown in FIG. 6 which is a plan view of the touch panel, the touch panel includes two L-shaped optical waveguide sections M and N provided along the periphery of a display screen of a rectangular display as seen in plan view, and the optical waveguide sections M and N define a rectangular frame. One of the two L-shaped optical waveguide sections opposed to each other with the aforementioned display screen therebetween is a light-emitting optical waveguide section M, and the other thereof is a light-receiving optical waveguide section N. A light-emitting element 5 is connected to an edge of the aforementioned light-emitting optical waveguide section M, and a light-receiving element 6 is connected to an edge of the aforementioned light-receiving optical waveguide section N. In FIG. 6, the reference numeral 20 designates cores serving as a passageway for light. The thickness of broken lines extending in a longitudinal direction indicates the thickness of a bundle of cores 20, and the thickness of broken lines branching off inwardly therefrom indicates the thickness of a single core 20. Also, the number of cores 20 is shown as abbreviated in FIG. 6.

A light beam emitted from the light-emitting element 5 is divided into multiple light beams by the cores 20 of the aforementioned light-emitting optical waveguide section M. The multiple light beams S parallel to the display screen of the display are emitted from the distal ends of the cores 20 of the optical waveguide section M toward the other side of the display screen. The distal ends of the cores 20 of the aforementioned light-receiving optical waveguide section N receive the emitted light beams S. These optical waveguide sections M and N cause the emitted light beams S to travel in a lattice form over the display screen of the display. When a portion of the display screen of the display is touched with a finger in this state, the finger blocks some of the emitted light beams S. The aforementioned light-receiving element 6 connected to the aforementioned light-receiving optical waveguide section N senses a light blocked portion to thereby detect the position (coordinates) of the portion touched with the finger.

There is a need to increase the size of the display screen of the display of the aforementioned touch panel. In conformity with the increase in the size of the display screen of the display, it is necessary to increase the size of the aforementioned optical waveguide for a touch panel (to increase the length of the optical waveguide sections M and N).

However, a photolithographic process is generally required for the production of the aforementioned optical waveguide sections M and N, and the range of exposure (a range in which uniform exposure can be performed) is limited by an exposure system for use in the photolithographic process. Thus, the length of the optical waveguide sections M and N produced at a time is also limited (in general, a maximum of approximately 30 cm).

To produce an optical waveguide having a length exceeding the aforementioned exposure range, it is contemplated to use an exposure system having a wide (long) exposure range or to arrange multiple optical waveguide sections U and V having the aforementioned conventional length along the four sides of the display screen of the display, as shown in FIG. 7.

However, the use of an exposure system having a wide (long) exposure range involves the need for the production of such a new system to necessitate a large initial investment. Additionally, an optical waveguide, which is in general made of resin, increases in dimensional shrinkage due to heat and the like as the length of the optical waveguide increases, to result in unstable dimensional accuracy. On the other hand, as shown in FIG. 7, when the multiple optical waveguide sections U and V having the conventional length are arranged, the light-emitting element 5 or the light-receiving element 6 is required for each of the optical waveguide sections U and V. Thus, as the size of the display screen of the display increases, the number of light-emitting elements 5 and light-receiving elements 6 to be used increases. This gives rise to the increase in manufacturing costs.

To reduce both the dimensional shrinkage and the number of optical elements (light-emitting elements 5 and light-receiving elements 6) to be used, it is contemplated to couple the multiple optical waveguide sections U and V having the aforementioned conventional length together in a longitudinal direction so as to be able to propagate light therethrough. Specifically, end portions of such optical waveguide sections U and V to be coupled to each other are brought into abutment with each other. Then, end surfaces of end portions of the cores 20 of the optical waveguide sections U and V are placed into intimate contact with each other in the abutment portion, so that the cores 20 are coupled to each other so as to be able to propagate light therethrough.

However, when the aforementioned abutting operation is actually effected, a gap of approximately 100 μm or more is in general created between the end surfaces of the aforementioned cores 20 in the abutment portion because of the influences of an under cladding layer and an over cladding layer around the cores 20. It is hence significantly difficult to place the end surfaces of the aforementioned cores 20 into intimate contact with each other. When the aforementioned gap is created, a light beam emitted from the end surface of one of the cores 20 in the abutment portion diverges radially widely, so that it is difficult for the end surface of the other of the cores 20 to receive the light beam. In addition, there is apprehension that the optical waveguide sections U and V are misaligned relative to each other along the abutment surfaces thereof during the aforementioned abutting operation. Even a slight misalignment between the optical waveguide sections U and V makes it more difficult for the end surface of the other of the cores 20 to receive the light beam, because the cores 20 are very thin. In this manner, merely bringing both the optical waveguide sections U and V into abutment with each other results in increased optical coupling losses of the cores 20 in the abutment portion. In particular, the multiple cores 20 in the light-receiving optical waveguide sections V transmit independent optical signals. It is hence necessary that such an optical signal is prevented from entering an adjacent one of the cores 20 in the abutment portion in the aforementioned optical waveguide sections V.

### SUMMARY OF THE INVENTION

An optical waveguide for a touch panel is provided in which, when multiple optical waveguide sections are coupled together, the optical coupling losses of cores are small in coupling portions thereof, and an optical signal does not enter an adjacent one of the cores.

An optical waveguide for a touch panel is configured to be disposed along the periphery of a display screen of a display of a touch panel. The optical waveguide comprises: a plurality of light-emitting optical waveguide sections; and a plurality of light-receiving optical waveguide sections, at least one of the light-emitting optical waveguide sections and at least one of the light-receiving optical waveguide sections being disposed in an alternating pattern along each edge of the display screen, the at least one light-emitting optical waveguide section and the at least one light-receiving optical waveguide section being coupled together by placing end surfaces of end portions of the at least one light-emitting optical waveguide section and the at least one light-receiving optical waveguide section in abutment with each other, the at least one light-emitting optical waveguide section including cores each having an end portion provided in the form of a light-emitting lens portion, the light-emitting lens portion having an end surface provided in the form of a light-emitting lens surface, the at least one light-receiving optical waveguide section including cores each having an end portion provided in the form of a light-receiving lens portion corresponding to the light-emitting lens portion, the light-receiving lens portion having an end surface provided in the form of a light-receiving lens surface for receiving a light beam emitted from the light-emitting lens surface.

In the optical waveguide for a touch panel, the at least one light-emitting optical waveguide section and the at least one light-receiving optical waveguide section are coupled together along each edge of the display screen of the display of the touch panel by placing the end surfaces of the end portions of the at least one light-emitting optical waveguide section and the at least one light-receiving optical waveguide section in abutment with each other. Among the optical waveguide sections coupled together in a coupling portion, the at least one light-emitting optical waveguide section includes the cores each having the end portion provided in the form of the light-emitting lens portion. The light-emitting lens portion has the end surface provided in the form of the light-emitting lens surface. The at least one light-receiving optical waveguide section includes the cores each having the end portion provided in the form of the light-receiving lens portion. The light-receiving lens portion has the end surface provided in the form of the light-receiving lens surface. Thus, an emitted light beam from the aforementioned light-emitting lens surface is emitted, with the diffusion of the light beam restrained properly by refraction through the lens surface. The light beam is received by the aforementioned light-receiving lens surface, and is guided into the core, with the light beam converged properly by refraction through the lens surface. As a result, optical coupling losses of the aforementioned light-emitting optical waveguide section and the aforementioned light-receiving optical waveguide section are made smaller. At the same time, the emitted light beam from the aforementioned light-emitting lens surface is allowed to properly enter the intended light-receiving lens portion, and is prevented from entering an unintended light-receiving lens portion adjacent to the intended light-receiving lens portion. Also, the multiple optical waveguide sections are coupled together in the aforementioned manner, and connected to an optical element, while being formed into what is called a single optical waveguide section group. It is hence unnecessary to connect an optical element for each of the optical waveguide sections. This reduces the number of optical elements to suppress manufacturing costs. Additionally, the optical waveguide sections used for the aforementioned coupling are those produced in an exposure range possessed by a typical exposure system without much difficulty and having conventional lengths. Thus, a dimensional shrinkage in the individual optical waveguide sections is reduced, so that the entire dimensional accuracy is stabilized even when the multiple optical waveguide sections are coupled together in the aforementioned manner.

In particular, when the light-receiving lens surface and the light-emitting lens surface are convex lens surfaces, the lens surfaces are excellent in converging characteristics. This further reduces the aforementioned optical coupling losses.

Also, when the light-receiving lens surface is greater in size than the light-emitting lens surface, a greater light-receiving region is provided in the aforementioned light-receiving lens portion. This further reduces the aforementioned optical coupling losses. Also, if a large misalignment occurs in the direction of the width or the height during the coupling of the optical waveguide sections, the aforementioned light-receiving lens surface is allowed to be positioned within the light-receiving region. Thus, the light beam emitted from the aforementioned light-emitting lens surface is allowed to properly enter the aforementioned light-receiving lens portion.

Further, when the light-emitting lens portion is of a substantially sector-shaped configuration which has a width gradually increasing toward the light-receiving lens portion and which has a distal end surface provided in the form of a light-emitting lens surface, the light beam emitted from the aforementioned light-emitting lens surface is made as a collimated light beam or a substantially collimated light beam by the action derived from the characteristic shape of the aforementioned light-emitting lens portion. This further reduces the aforementioned optical coupling losses.

Also, when the light-receiving lens portion is of a substantially sector-shaped configuration which has a width gradually increasing toward the light-emitting lens portion and which has a distal end surface provided in the form of a light-receiving lens surface, the light beam entering through the aforementioned light-receiving lens surface is guided efficiently in the direction of the optical propagation of the cores by the action derived from the characteristic shape of the aforementioned light-receiving lens portion. This improves optical propagation efficiency.

### BRIEF DESCRIPTION OF THE DRAWINGS

FIG. 1 is a plan view schematically showing an optical waveguide for a touch panel according to one preferred embodiment.

FIG. 2 is a sectional view schematically showing principal parts taken along the line X-X of FIG. 1.

FIG. 3 is a plan view schematically showing a lens portion provided in a distal end portion of a core.

FIGS. 4A and 4B are plan views schematically showing coupling portions of a light-emitting optical waveguide section and a light-receiving optical waveguide section.

FIG. 5 is a plan view schematically showing optical elements connected to the aforementioned optical waveguide for a touch panel.

FIG. 6 is a plan view schematically showing a conventional optical waveguide for a touch panel.

FIG. 7 is a plan view schematically showing another conventional optical waveguide for a touch panel.

### DETAILED DESCRIPTION OF THE INVENTION

Next, a preferred embodiment of the present invention will now be described in detail with reference to the drawings.

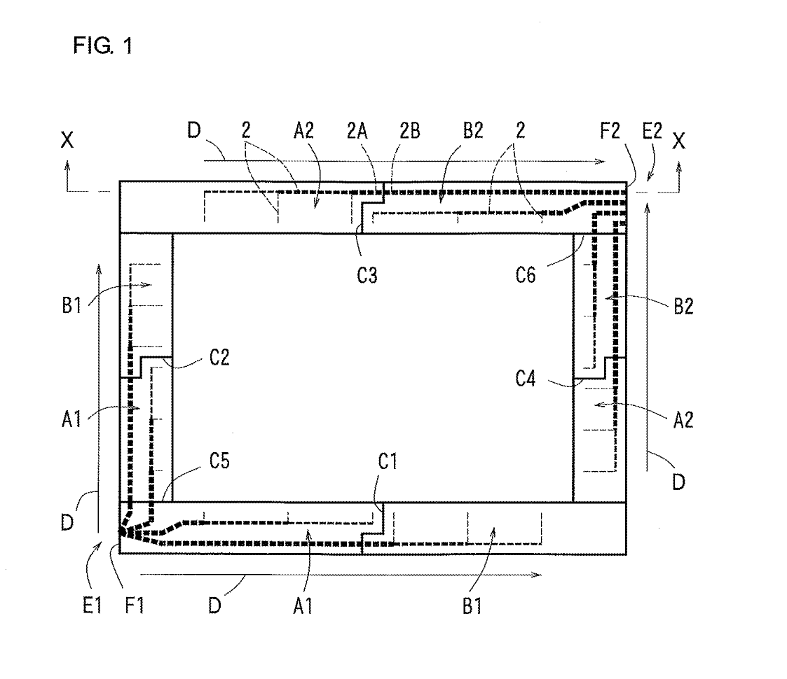

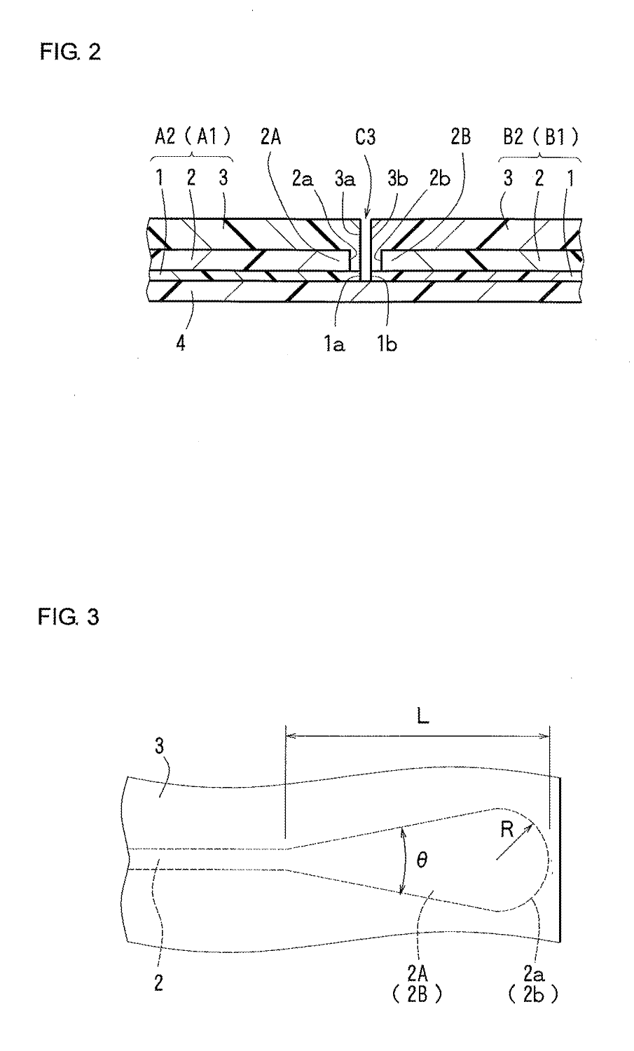

FIG. 1 shows an optical waveguide for a touch panel according to one preferred embodiment. As shown in plan view in FIG. 1, the optical waveguide for a touch panel according to this preferred embodiment is in the form of a rectangular frame as seen in plan view. Multiple (as seen in FIG. 1, two) optical waveguide sections A1 and B1, each having an elongated rectangular configuration, are coupled together in a longitudinal direction on each side of one L-shaped section constituting the rectangular frame, so that a light-emitting optical waveguide section group is formed. Multiple (as seen in FIG. 1, two) optical waveguide sections A2 and B2, each having an elongated rectangular configuration, are coupled together in a longitudinal direction on each side of the other L-shaped section constituting the rectangular frame, so that a light-receiving optical waveguide section group is formed. End portions of two of the optical waveguide sections A1, A2, B1 and B2 which are coupled to each other are in the form of protruding and recessed portions in this preferred embodiment, and are brought into abutment with each other by the meshing engagement of the protruding and recessed portions. By the abutment, two of the optical waveguide sections A1, A2, B1 and B2 are coupled together linearly so as to be able to propagate light therethrough (in coupling portions C1 to C4). Arrows D in FIG. 1 indicate the direction of the propagation of light in the optical waveguide sections A1, A2, B1 and B2 coupled together. In other words, one side of the optical waveguide sections A1, A2, B1 and B2 coupled together includes the light-emitting optical waveguide sections A1 and A2, and the other side thereof includes the light-receiving optical waveguide sections B1 and B2. End portions of cores 2 in the aforementioned light-emitting optical waveguide sections A1 and A2 and end portions of cores 2 in the aforementioned light-receiving optical waveguide sections B1 and B2 which are positioned in the coupling portions C1 to C4 are placed in abutment with each other, as shown in a sectional view (FIG. 2) taken along the line X-X of FIG. 1. As shown in an enlarged plan view (FIG. 3) of such an abutment portion, each of the end portions of the cores 2 of the aforementioned light-emitting optical waveguide sections A1 and A2 is provided in the form of a light-emitting lens portion 2A. The light-emitting lens portion 2A has an end surface provided in the form of a light-emitting lens surface 2a. Each of the end portions of the cores 2 of the aforementioned light-receiving optical waveguide sections B1 and B2 is provided in the form of a light-receiving lens portion 2B corresponding to the aforementioned light-emitting lens portion 2A. The light-receiving lens portion 2B has an end surface provided in the form of a light-receiving lens surface 2b (with reference to FIGS. 2 and 3) which receives a light beam emitted from the aforementioned light-emitting lens surface 2a.

At a pair of corners E1 and E2 of the aforementioned rectangular frame in this preferred embodiment, end portions of the optical waveguide sections A1 and B2 on one side are coupled to side surfaces of end portions of the optical waveguide sections A1 and B2 on the other side at right angles so as to be able to propagate light therethrough (in coupling portions C5 and C6). Also in the coupling portions C5 and C6 at these corners E1 and E2, end portions of the cores 2 are placed in abutment with each other in a manner similar to that in the coupling portions C1 to C4 of the aforementioned linear portions. Specifically, one of the abutment portions is provided in the form of a light-emitting lens portion 2A (with reference to FIGS. 2 and 3). The light-emitting lens portion 2A has an end surface provided in the form of a light-emitting lens surface 2a. The other of the abutment portions is provided in the form of a light-receiving lens portion 2B (with reference to FIGS. 2 and 3) corresponding to the aforementioned light-emitting lens portion 2A. The light-receiving lens portion 2B has an end surface provided in the form of a light-receiving lens surface 2b which receives a light beam emitted from the aforementioned light-emitting lens surface 2a.

With the optical waveguide sections A1, A2, B1 and B2 coupled together in the form of a frame in the aforementioned manner, the cores 2 serving as a passageway for light are patterned to extend from outer edges F1 and F2 at the pair of opposed corners E1 and E2 of the aforementioned frame to inner peripheral edges of the frame and to be arranged in a parallel, equally spaced relationship. In FIG. 1, the cores 2 are indicated by broken lines. The thickness of broken lines extending in a longitudinal direction indicates the thickness of a bundle of cores 2, and the thickness of broken lines branching off inwardly therefrom indicates the thickness of a single core 2. Also, the number of cores 2 is shown as abbreviated in FIG. 1.

In this manner, the end portions of the cores 2 for abutment with each other are provided in the form of the lens portions 2A and 2B. This reduces optical coupling losses between the cores 2 for abutment with each other to achieve the proper propagation of light. Thus, coupling the optical waveguide sections A1, A2, B1 and B2 together by bringing the end portions thereof into abutment with each other allows the proper increase in the size of the optical waveguide for a touch panel.

More specifically, each of the aforementioned optical waveguide sections A1, A2, B1 and B2, as shown in FIG. 2 that is a vertical sectional view thereof (a sectional view taken along the line X-X of FIG. 1), includes an under cladding layer 1 having an elongated rectangular configuration, the multiple cores 2 formed in a predetermined pattern on a surface of this under cladding layer 1, and an over cladding layer 3 formed on the surface of the aforementioned under cladding layer 1 so as to cover the cores 2. An end surface 1a of the aforementioned under cladding layer 1 and an end surface 3a of the over cladding layer 3 are provided either so as to be flush with a distal end surface of the aforementioned light-emitting lens surface 2a and a distal end surface of the light-receiving lens surface 2b or so as to cover the distal end surfaces of the aforementioned lens surfaces 2a and 2b (in FIG. 2, so as to cover the distal end surfaces of the aforementioned lens surfaces 2a and 2b). The end surfaces 1a and 3a of the cladding layers 1 and 3 in the light-emitting optical waveguide sections A1 and A2 and the end surfaces 1b and 3b of the cladding layers 1 and 3 in the light-receiving optical waveguide sections B1 and B2 are placed in abutment with each other, whereby the light-emitting optical waveguide sections A1 and A2 and the light-receiving optical waveguide sections B1 and B2 are coupled together in the aforementioned manner so as to be able to propagate light therethrough. In FIG. 2, the reference numeral 4 designates a substrate which supports the aforementioned light-emitting optical waveguide sections A1 and A2 and the light-receiving optical waveguide sections B1 and B2. Also in FIG. 2, a slight gap is shown as existing between the abutment portions of the aforementioned light-emitting optical waveguide sections A1 and A2 and the light-receiving optical waveguide sections B1 and B2.

In the aforementioned abutting condition, there is in general a distance of approximately 100 μm or more between the distal end of the aforementioned light-emitting lens surface 2a and the distal end of the light-receiving lens surface 2b because of the influences of the formation of the aforementioned cladding layers 1 and 3, the abutting operation, and the like. Even in such a case, the converging action of the aforementioned lens portions 2A and 25 allows the reduction in the optical coupling losses between the cores 2 for abutment with each other.

Examples of the aforementioned light-emitting lens portion 2A include convex lenses having convex lens surfaces in the shape of an arc, an elliptical arc and the like, as seen in plan view. In particular, the light-emitting lens portion 2A is preferably of a substantially sector-shaped configuration which has a width gradually increasing from the width of the cores 2 toward the aforementioned light-receiving lens portion 2B and which has a distal end surface provided in the form of the light-emitting lens surface 2a, as shown in plan view in FIG. 3, from the viewpoints of the abilities to emit a collimated light beam or a substantially collimated light beam and to reduce the optical coupling losses with the aforementioned light-receiving lens portion 2B. The dimensions of the light-emitting lens portion 2A of a substantially sector-shaped con figuration are generally as follows: the length L thereof is in the range of 0.2 to 5.0 mm; the central angle θ of the substantially sector-shaped con figuration is in the range of 2 to 20 degrees; and the radius of curvature R of the light-emitting lens surface 2a is in the range of 10 to 200 μm.

Examples of the aforementioned light-receiving lens portion 2B also include convex lenses similar to those for the light-emitting lens portion 2A. In particular, the light-receiving lens portion 2B is preferably of the configuration shown in FIG. 3 similar to that of the aforementioned light-emitting lens portion 2A, that is, of a substantially sector-shaped configuration which has a width gradually increasing from the width of the cores 2 toward the aforementioned light-emitting lens portion 2A and which has a distal end surface provided in the form of the light-receiving lens surface 2b from the viewpoints of the abilities to guide a light beam entering through the light-receiving lens surface 2b efficiently in the direction of the optical propagation of the cores 2 and to improve optical propagation efficiency. The dimensions of the light-receiving lens portion 2B of the substantially sector-shaped configuration are generally as follows: the length L thereof is in the range of 0.2 to 5.0 mm; the central angle θ of the substantially sector-shaped configuration is in the range of 2 to 20 degrees; and the radius of curvature R of the light-receiving lens surface 2b is in the range of 10 to 200 μm.

Preferably, the aforementioned light-receiving lens surface 2b is greater than the aforementioned light-emitting lens surface 2a. For example, when the width of the aforementioned light-receiving lens surface 2b is equal to or greater than the width of the aforementioned light-emitting lens surface 2a, the aforementioned light-receiving lens surface 2b is allowed to be positioned within a light-receiving region even if a large misalignment occurs in the direction of the width during the coupling of the aforementioned optical waveguide sections A1, A2, B1 and B2. When the height of the aforementioned light-receiving lens surface 2b is equal to or greater than the height of the aforementioned light-emitting lens surface 2a, the aforementioned light-receiving lens surface 2b is allowed to be positioned within the light-receiving region even if a large misalignment occurs in the direction of the height during the coupling of the aforementioned optical waveguide sections A1, A2, B1 and B2. In either case, a light beam emitted from the aforementioned light-emitting lens surface 2a is allowed to properly enter the aforementioned light-receiving lens portion 2B.

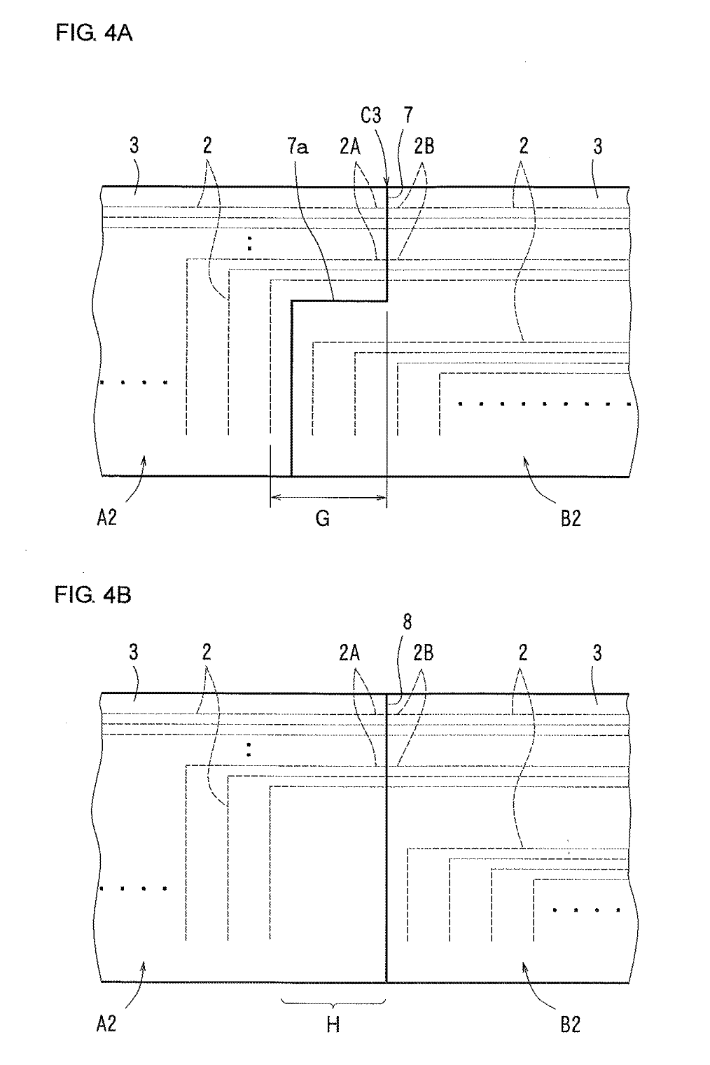

Further, an abutment surface (the end surface 1a and 3a of the cladding layers 1 and 3) 7 has a step portion (uneven portion) 7a in this preferred embodiment, as shown in FIG. 4A which is a plan view of a coupling portion (for example, the coupling portion C3 shown in FIG. 1) where the aforementioned light-emitting optical waveguide sections A1 and A2 and the light-receiving optical waveguide sections B1 and 52 are coupled together linearly. The use of this step portion 7a allows the formation of the cores 2 into the depth of the step portion 7a of the aforementioned abutment surface 7 in the light-receiving optical waveguide section (the right-hand optical waveguide section as seen in FIG. 4A) B2, and eliminates a region where the cores 2 are absent in the end portion of the light-receiving optical waveguide section B2. This eliminates a region where no light beams travel over a display screen of a display to allow the detection of a thin object and the detection in a wide range. Specifically, the cores 2 extending in the longitudinal direction cannot be bent in the direction of the width near the aforementioned abutment surface 7 in the light-emitting optical waveguide section (the left-hand optical waveguide section as seen in FIG. 4A) A2, but a certain distance G from the aforementioned abutment surface 7 is required for the formation of the cores 2 bent in such a manner. When an abutment surface is formed linearly (without any step portion) as seen in plan view under these circumstances as shown in FIG. 4B, a region H in which the cores 2 are absent is created. This produces the region where no light beams travel over the display screen of the display to give rise to apprehension that the requirements for the detection of a thin object and the detection in a wide range cannot be satisfied, but can meet the requirements for the detection of a thick object and the detection in a limited range. The same holds true for the coupling portions C1, C2 and C4 where the light-emitting optical waveguide sections A1 and A2 and the light-receiving optical waveguide sections B1 and B2 are coupled linearly, in addition to the aforementioned coupling portion C3.

The aforementioned optical waveguide for a touch panel is manufactured in a manner to be described below. The aforementioned light-emitting optical waveguide sections A1 and A2 and the light-receiving optical waveguide sections B1 and B2 which are produced in an exposure range possessed by a typical exposure system without much difficulty and which have conventional lengths are coupled together so as to be able to propagate light therethrough by bringing the end portions thereof into abutment with each other. In this state, the light-emitting optical waveguide sections A1 and A2 and the light-receiving optical waveguide sections B1 and B2 coupled together is bonded onto the substrate 4 in the form of a frame.

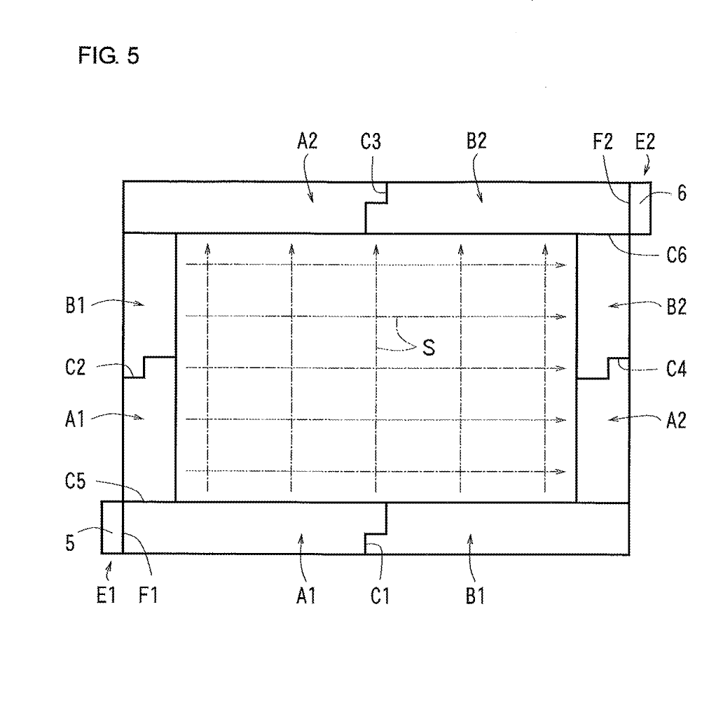

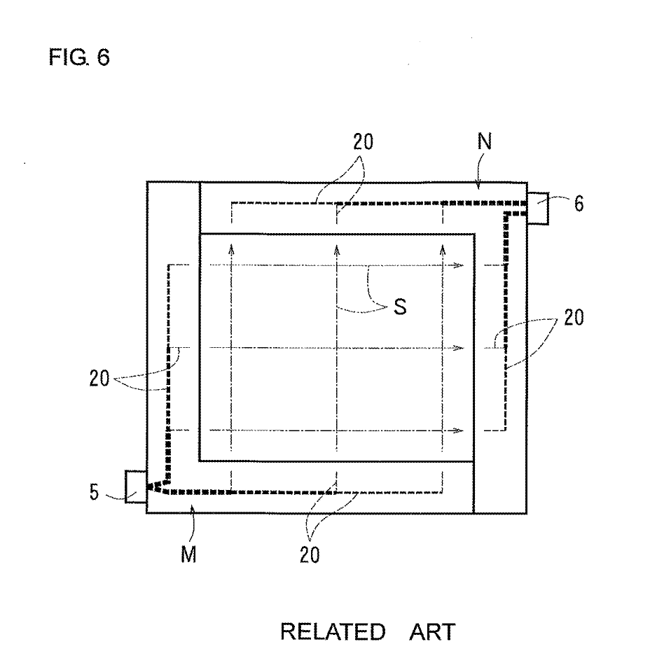

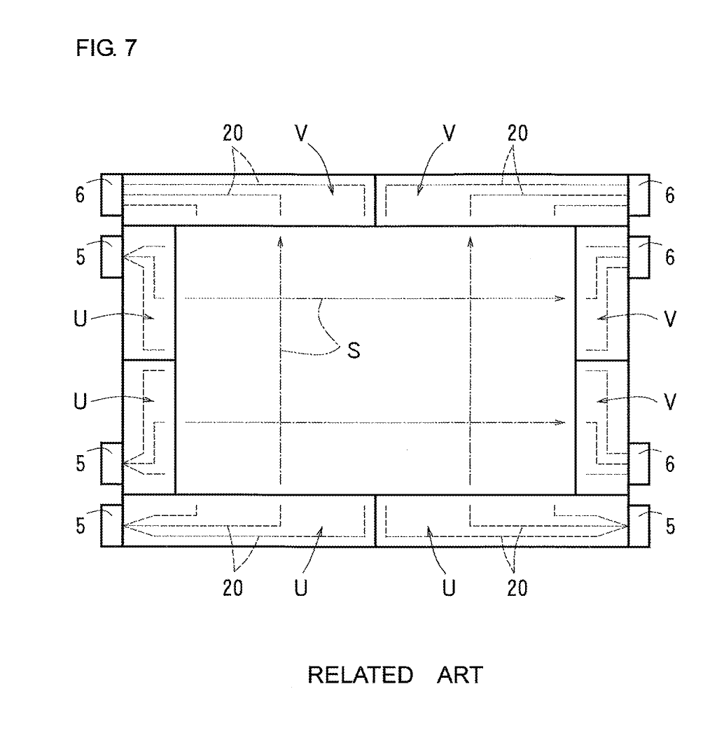

Then, when the aforementioned optical waveguide for a touch panel which is in the form of a rectangular frame is used for a touch panel, as shown in FIG. 5, a single light-emitting element 5 is connected to the outer edge [a proximal end portion of the aforementioned multiple cores 2 (with reference to FIG. 1)] F1 at one corner E1 out of the pair of corners E1 and E2 of the aforementioned frame, and a single light-receiving element 6 is connected to the outer edge [a proximal end portion of the aforementioned multiple cores 2 (with reference to FIG. 1)] F2 at the other corner E2. This allows light beams S to travel in a lattice form in the interior space of the aforementioned frame. Then, the aforementioned optical waveguide for a touch panel which is in the form of a frame is disposed along the rectangle of the periphery of the display screen of the rectangular display of the touch panel so as to surround the display screen.

When the multiple optical waveguide sections A1, A2, B1 and B2 are used for the sides constituting the aforementioned frame, required optical elements are only the single light-emitting element 5 and the single light-receiving element 6 because the multiple optical waveguide sections A1, A2, B1 and B2 are coupled together so as to be able to propagate light therethrough. It is not necessary that an optical element is provided for each of the optical waveguide sections A1, A2, B1 and B2. Therefore, manufacturing costs are suppressed.

Although two of the optical waveguide sections A1, A2, B1 and B2 are coupled together on each of the four sides constituting the rectangular frame in the aforementioned preferred embodiment, three or more of the optical waveguide sections A1, A2, B1 and B2 may be coupled together. For example, when three optical waveguide sections are coupled together, two coupling portions are produced. The two optical waveguide sections coupled together in one of the two coupling portions are such that one is selected from among the light-emitting optical waveguide sections A1 and A2 and the other is selected from among the light-receiving optical waveguide sections B1 and B2. The two optical waveguide sections coupled together in the coupling portion (the remaining coupling portion) adjacent to the aforementioned coupling portion are such that the aforementioned selected one of the light-receiving optical waveguide sections B1 and B2 is replaced with one selected from among the light-emitting optical waveguide sections A1 and A2 and the other is selected from among the light-receiving optical waveguide sections B1 and B2. In other words, an optical waveguide section sandwiched between two coupling portions has the light-receiving lens portion 2B provided on the side of one of the two coupling portions, and the light-emitting lens portion 2A provided on the side of the other coupling portion. The same applies to the coupling of four or more optical waveguide sections.

If a defect occurs, for example, in one of the optical waveguide sections A1, A2, B1 and B2 in the optical waveguide for a touch panel according to this preferred embodiment which is produced by coupling the optical waveguide sections A1, A2, B1 and B2 having the conventional lengths together in the aforementioned manner, it is only necessary to replace the one of the optical waveguide sections A1, A2, B1 and B2 which has the defect. The entire optical waveguide need not be discarded. This reduces waste of materials for the formation of the optical waveguide sections A1, A2, B1 and B2. On the other hand, when a defect occurs in a long optical waveguide produced at one time, it is necessary to discard the entire long optical waveguide. This results in much waste of materials for the formation of the optical waveguide.

Further, when a long optical waveguide is produced at one time, a dimensional shrinkage due to heat and the like increases during the production, resulting in unstable dimensional accuracy. In the optical waveguide for a touch panel according to the aforementioned preferred embodiment, however, the optical waveguide sections A1, A2, B1 and B2 having the conventional lengths are coupled together in the aforementioned manner to make the optical waveguide long. Thus, a dimensional shrinkage in the individual optical waveguide sections A1, A2, B1 and B2 is reduced, so that the entire dimensional accuracy is stabilized even when the multiple optical waveguide sections A1, A2, B1 and B2 are coupled together in the aforementioned manner.

Next, an inventive example of the present invention will be described in conjunction with a comparative example. It should be noted that the present invention is not limited to the inventive example.

### Examples

A ray tracing simulation was performed using optical simulation software known as “LightTools” produced by Optical Research Associates.

### <Simulation Model of Light-Emitting Lens Portion>

A light-emitting lens portion which was set was of a substantially sector-shaped configuration (having a central angle of 4 degrees) which had a width gradually increasing from the width (15 μm) of cores and which had a distal end provided in the form of a light-emitting convex lens surface (having a radius of curvature of 24 μm). The light-emitting lens portion had a length of 0.40 mm, and a height of 50 μm that was equal to the height of the cores.

### <Simulation Model of Light-Receiving Lens Portion>

A light-receiving lens portion which was set was of a substantially sector-shaped configuration (having a central angle of 2 degrees) which had a width gradually increasing from the width (15 μm) of cores and which had a distal end provided in the form of a light-receiving convex lens surface (having a radius of curvature of 100 μm). The light-receiving lens portion had a length of 1.75 mm, and a height of 50 μm that was equal to the height of the cores.

### <Simulation Model of Comparative Example>

Cores each having a distal end which was not provided in the form of a lens portion were used.

Specifically, each of the cores had a constant width (15 μm) and a constant height (50 μm) to the distal end, and included a distal end surface which was a vertical flat surface.

### <Optical Coupling Losses>

In the aforementioned inventive example and the comparative example, a light-emitting distal end and a light-receiving distal end of the simulation model were placed in abutment with each other, and optical coupling losses were simulated while a distance between the distal ends and a horizontal misalignment between a light-emitting central axis and a light-receiving central axis were varied. In this simulation, the refractive index of the core was 1.57, the refractive indices of an under cladding layer and an over cladding layer were 1.51, the number of rays for tracing was one hundred thousand, and the wavelength of light was 850 nm. The results were listed in Table 1 below. An optical coupling loss of less than 6 dB was evaluated as being “good” and indicated by an open circle; and an optical coupling loss of not less than 6 dB was evaluated as being “unacceptable” and indicated by a cross.

TABLE 1

| Distance | | Optical Coupling | |
|---|---|---|---|
| between | Horizontal | Losses (dB) | |
| Distal Ends | Misalignment | Inventive | Comparative |
| (μm) | (μm) | Example | Example |

| | | | | | |
|---|---|---|---|---|---|
| 120 | 0 | 3.86 | ◯ | 8.11 | X |
| 160 | 0 | 4.76 | ◯ | 10.19 | X |
| 200 | 0 | 5.65 | ◯ | 12.08 | X |
| 80 | 30 | 4.68 | ◯ | 16.42 | X |
| 200 | 10 | 5.73 | ◯ | 12.02 | X |

The aforementioned results show that the inventive example prevents the increase in optical coupling loss and is able to properly propagate light, as compared with the comparative example, even when the distance between the distal ends of the lenses increases or even when the lenses are horizontally misaligned relative to each other.

Further, results similar to those described above were obtained when the shape, dimensions and the like of the lens portions in the aforementioned inventive example were varied, for example when the lens portions had a constant width, rather than the substantially sector-shaped configuration described above. In particular, a suitable result was shown when the size of the light-receiving convex lens surface was equal to or greater than that of the light-emitting convex lens surface.

An optical waveguide for a touch panel is applicable to an optical waveguide for use as a detection means (a position sensor) for detecting a finger touch position and the like in a touch panel.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. An optical waveguide for a touch panel, the optical waveguide being configured to be disposed along the periphery of a display screen of a display of a touch panel, the optical waveguide comprising:
a plurality of light-emitting optical waveguide sections; and
a plurality of light-receiving optical waveguide sections,
wherein at least one of the light-emitting optical waveguide sections and at least one of the light-receiving optical waveguide sections are disposed in an alternating pattern along each edge of the display screen,
wherein the at least one light-emitting optical waveguide section and the at least one light-receiving optical waveguide section are coupled together by placing end surfaces of end portions of the at least one light-emitting optical waveguide section and the at least one light-receiving optical waveguide section in abutment with each other,
wherein the at least one light-emitting optical waveguide section includes cores, each having an end portion provided in the form of a light-emitting lens portion,
wherein the light-emitting lens portion has an end surface provided in the form of a light-emitting lens surface,
wherein the at least one light-receiving optical waveguide section includes cores, each having an end portion provided in the form of a light-receiving lens portion corresponding to the light-emitting lens portion, and
wherein the light-receiving lens portion has an end surface provided in the form of a light-receiving lens surface for receiving a light beam emitted from the light-emitting lens surface.

2. The optical waveguide for a touch panel according to claim 1, wherein the light-receiving lens surface and the light-emitting lens surface are convex lens surfaces.

3. The optical waveguide for a touch panel according to claim 1, wherein the light-receiving lens surface is greater in size than the light-emitting lens surface.

4. The optical waveguide for a touch panel according to claim 2, wherein the light-receiving lens surface is greater in size than the light-emitting lens surface.

5. The optical waveguide for a touch panel according to claim 1, wherein the light-emitting lens portion is of a substantially sector-shaped configuration which has a width gradually increasing toward the light-receiving lens portion and which has a distal end surface provided in the form of a light-emitting lens surface.

6. The optical waveguide for a touch panel according to claim 2, wherein the light-emitting lens portion is of a substantially sector-shaped configuration which has a width gradually increasing toward the light-receiving lens portion and which has a distal end surface provided in the form of a light-emitting lens surface.

7. The optical waveguide for a touch panel according to claim 3, wherein the light-emitting lens portion is of a substantially sector-shaped configuration which has a width gradually increasing toward the light-receiving lens portion and which has a distal end surface provided in the form of a light-emitting lens surface.

8. The optical waveguide for a touch panel according to claim 4, wherein the light-emitting lens portion is of a substantially sector-shaped configuration which has a width gradually increasing toward the light-receiving lens portion and which has a distal end surface provided in the form of a light-emitting lens surface.

9. The optical waveguide for a touch panel according to claim 1, wherein the light-receiving lens portion is of a substantially sector-shaped configuration which has a width gradually increasing toward the light-emitting lens portion and which has a distal end surface provided in the form of a light-receiving lens surface.

10. The optical waveguide for a touch panel according to claim 2, wherein the light-receiving lens portion is of a substantially sector-shaped configuration which has a width gradually increasing toward the light-emitting lens portion and which has a distal end surface provided in the form of a light-receiving lens surface.

11. The optical waveguide for a touch panel according to claim 3, wherein the light-receiving lens portion is of a substantially sector-shaped configuration which has a width gradually increasing toward the light-emitting lens portion and which has a distal end surface provided in the form of a light-receiving lens surface.

12. The optical waveguide for a touch panel according to claim 4, wherein the light-receiving lens portion is of a substantially sector-shaped configuration which has a width gradually increasing toward the light-emitting lens portion and which has a distal end surface provided in the form of a light-receiving lens surface.

13. The optical waveguide for a touch panel according to claim 5, wherein the light-receiving lens portion is of a substantially sector-shaped configuration which has a width gradually increasing toward the light-emitting lens portion and which has a distal end surface provided in the form of a light-receiving lens surface.

14. The optical waveguide for a touch panel according to claim 6, wherein the light-receiving lens portion is of a substantially sector-shaped configuration which has a width gradually increasing toward the light-emitting lens portion and which has a distal end surface provided in the form of a light-receiving lens surface.

15. The optical waveguide for a touch panel according to claim 7, wherein the light-receiving lens portion is of a substantially sector-shaped configuration which has a width gradually increasing toward the light-emitting lens portion and which has a distal end surface provided in the form of a light-receiving lens surface.

16. The optical waveguide for a touch panel according to claim 8, wherein the light-receiving lens portion is of a substantially sector-shaped configuration which has a width gradually increasing toward the light-emitting lens portion and which has a distal end surface provided in the form of a light-receiving lens surface.
